(19) United States
(12) Patent Application Publication
(10) Pub. No.: US 2025/0319447 A1
(43) Pub. Date: Oct. 16, 2025

(54) SOUND-ABSORBING PARTICLES, METHOD FOR PREPARING SAME AND ELECTRONIC DEVICE

(71) Applicant: AAC Microtech (Changzhou) Co., Ltd., Changzhou City (CN)

(72) Inventors: Jie Zhang, Changzhou (CN); Zhongyang Wang, Changzhou (CN); Hezhi Wang, Changzhou (CN); Chao Wang, Changzhou (CN)

(21) Appl. No.: 18/805,473

(22) Filed: Aug. 14, 2024

Related U.S. Application Data
(63) Continuation of application No. PCT/CN2024/087800, filed on Apr. 15, 2024.

(51) Int. Cl. B01F 23/41; H04R 1/02; H04R 1/28

(52) U.S. Cl. CPC B01F 23/4105; H04R 1/025; H04R 1/288

(57) ABSTRACT

Sound-absorbing particles, a method for preparing the same and a related device are provided. The method for preparing the same includes: adding powdered molecular sieve into water and stirring evenly, and adding adhesive and continuing to stir evenly to obtain precursor slurry; adding the precursor slurry, as a dispersed phase, into a microfluidic device, and dispersing, by the microfluidic device, the precursor slurry using a continuous phase into emulsion droplets flowing in a front section of a microchannel of the microfluidic device; extruding the emulsion droplets to have a predetermined shape by adjusting a shape of a rear section of the microchannel of the microfluidic device to obtain deformed emulsion droplets; solidifying the deformed emulsion droplets by setting a temperature in the rear section of the microchannel, to obtain solidified emulsion droplets; and sublimating and drying the solidified emulsion droplets to obtain the sound-absorbing particles.

### CROSS REFERENCE TO RELATED APPLICATIONS

The present application is a continuation of PCT Patent Application No. PCT/CN2024/087800, filed Apr. 15, 2024, which is incorporated by reference herein in its entirety.

### TECHNICAL FIELD

The present disclosure relates to the technical field of acoustic technology, and in particular relates to sound-absorbing particles, a method for preparing the same and a related device.

### BACKGROUND

With the continuous popularization of smart phones, Bluetooth headphones and other portable electronic devices, the demand of people for audio quality is also increasing, in order to improve the sounding effect of a speaker, one of the common ways is to fill a rear cavity of the speaker with sound-absorbing materials, so as to increase a virtual volume of the rear cavity, thereby improving the audio quality.

After the speaker is packaged, a size of the volume of the rear cavity affects the overall resonance frequency, as the smaller the cavity is, the higher the resonance frequency is. Molecular sieve, as a kind of porous structural material, can continuously adsorb and desorb the air in the cavity when the molecular sieve vibrates in the rear cavity, thereby indirectly increasing the volume of the cavity.

Limited by an overall size of the portable device, in order to obtain a better low-frequency effect of the speaker, on the one hand, the resonance frequency of the speaker is required to be as low as possible, and on the other hand, the rear cavity of the speaker is required to be as small as possible to save space. However, the frequency reduction performance of the filled material in the rear cavity of the speaker in the existing technology is unable to meet the above requirements.

Therefore, there is an urgent need for sound-absorbing particles with high frequency reduction performance, a method for preparing the same and a related device to solve the above problem.

### SUMMARY

An object according to the present disclosure is to provide sound-absorbing particles, a method for preparing the same and a related device, so as to solve the problem of low frequency reduction performance of a filled material in a rear cavity of a speaker in the existing technology.

In a first aspect, a method for preparing sound-absorbing particles includes the following operations:
S1, adding powdered molecular sieve into water and stirring evenly, and adding adhesive and continuing to stir evenly, to obtain =precursor slurry;
S2, adding the precursor slurry, as a dispersed phase, into a microfluidic device, and dispersing, by the microfluidic device, the precursor slurry using a continuous phase into emulsion droplets flowing in a front section of a microchannel of the microfluidic device;
S3, extruding the emulsion droplets to have a predetermined shape by adjusting a shape of a rear section of the microchannel of the microfluidic device, to obtain deformed emulsion droplets having the predetermined shape;
S4, solidifying the deformed emulsion droplets by setting a temperature in the rear section of the microchannel, to obtain solidified emulsion droplets; and
S5, sublimating and drying the solidified emulsion droplets, to obtain the sound-absorbing particles.

As an improvement, a mass ratio of the molecular sieve, to the adhesive, and to the water is 1:0.02-0.10:0.50-2.

As an improvement, the continuous phase added into the microfluidic device for dispersing the dispersed phase includes an oil having a freezing point lower than a freezing point of the precursor slurry.

As an improvement, the continuous phase further includes an unsaturated fatty acid or antifreeze to keep the oil in a flowable liquid state in the microchannel of the microfluidic device.

As an improvement, the front section of the microchannel is tubular, and the rear section of the microchannel is in a preset shape for extruding the emulsion droplets to have the predetermined shape.

As an improvement, a maximum cross-sectional area of the emulsion droplets in the front section of the microchannel is larger than a maximum cross-sectional area of the deformed emulsion droplets in the rear section of the microchannel.

As an improvement, the preset shape is one of a flat shape, a stepped shape, an annular shape and a tubular shape.

As an improvement, the microfluidic device adopts one of a stepped microchannel, a T-shaped vertically staggered microchannel and a fluid-focusing microchannel.

As an improvement, a temperature in the rear section of the microchannel is higher than a temperature of a freezing point of the continuous phase and lower than a temperature of a freezing point of the dispersed phase, and the solidified emulsion droplets are obtained by solidifying the deformed emulsion droplets by the rear section of the microchannel.

As an improvement, the molecular sieve has one or more of an MFI structure, a FER structure, and a MEL structure, the molecular sieve includes silicon oxide and a metal element oxide, a molar ratio of silicon element in the silicon oxide to metal element in the metal element oxide is greater than or equal to 100, and the metal element includes one or more of aluminum, iron, zinc, and zirconium.

As an improvement, the sound-absorbing particles are one of spherical, disc-shaped, elliptical spherical, or rod-shaped.

In a second aspect, sound-absorbing particles are provided according to the present disclosure, which are prepared by using a method for preparing the sound-absorbing particles;

where the method includes:
S1, adding powdered molecular sieve into water and stirring evenly, and adding adhesive and continuing to stir evenly, to obtain precursor slurry;
S2, adding the precursor slurry, as a dispersed phase, into a microfluidic device, and dispersing, by the microfluidic device, the precursor slurry using a continuous phase into emulsion droplets flowing in a front section of a microchannel of the microfluidic device;
S3, extruding the emulsion droplets to have a predetermined shape by adjusting a shape of a rear section of the microchannel of the microfluidic device, to obtain deformed emulsion droplets having the predetermined shape;
S4, solidifying the deformed emulsion droplets by setting a temperature in the rear section of the microchannel, to obtain solidified emulsion droplets; and
S5, sublimating and drying the solidified emulsion droplets, to obtain the sound-absorbing particles.

In a third aspect, a speaker box is provided according to the present disclosure, which includes a housing having an accommodating space, a sounding unit accommodated and fixed in the accommodating space, and a sound-conducting channel, the housing includes an upper cover and a lower cover cooperating with the upper cover, the sound-conducting channel is formed in the upper cover, the sounding unit, the upper cover and the lower cover jointly define a rear cavity, the sounding unit and the upper cover are spaced apart and jointly define a front acoustic cavity, the front acoustic cavity is in communication with an exterior environment through the sound-conducting channel, the sound-conducting channel and the front acoustic cavity jointly form a front cavity, and the rear cavity is filled with the above sound-absorbing particles.

In a fourth aspect, an electronic device is provided according to the present disclosure, which includes the above speaker box.

Compared with the existing technology, the method for preparing sound-absorbing particles includes the following operations: adding the powdered molecular sieve into the water and stirring evenly, adding the adhesive and continuing to stir evenly, to obtain the precursor slurry; adding the precursor slurry as the dispersed phase into the microfluidic device, and dispersing the precursor slurry through the continuous phase into the emulsion droplets flowing in the front section of the microchannel of the microfluidic device by the microfluidic device; extruding the emulsion droplets to have the predetermined shape by adjusting the shape of the rear section of the microchannel of the microfluidic device, to obtain the deformed emulsion droplets having the predetermined shape; solidifying the deformed emulsion droplets by setting the temperature in the rear section of the microchannel, to obtain the solidified emulsion droplets; and sublimating and drying the solidified emulsion droplets, to obtain the sound-absorbing particles. The microfluidic device is used to obtain the sound-absorbing particles with different shapes, and the frequency reduction performance can be improved when the sound-absorbing particles are applied to the rear cavity of the speaker, thereby improving the acoustic performance of the speaker.

### BRIEF DESCRIPTION OF THE DRAWINGS

In order for a clearer illustration of technical solutions in embodiments of the present disclosure or the conventional technology, drawings used in the description of the embodiments or the conventional technology are described briefly hereinafter. Apparently, the drawings described in the following illustrate some embodiments of the present disclosure, other drawings may be obtained by those ordinarily skilled in the art based on these drawings without any creative effort.

FIG. 1 is a flowchart of a method for preparing sound-absorbing particles according to a first embodiment of the present disclosure;

FIG. 2 is a schematic structural diagram of a T-shaped vertically staggered microchannel according to a first specific embodiment of the present disclosure;

FIG. 3 is a schematic structural diagram of a T-shaped vertically staggered microchannel according to a second specific embodiment of the present disclosure;

FIG. 4 is a schematic structural diagram of a fluid-focusing microchannel according to a third specific embodiment of the present disclosure; and

FIG. 5 is a cross-sectional view of a speaker box according to a third embodiment.

### DETAILED DESCRIPTION OF THE EMBODIMENTS

The technical solutions in the embodiments of the present disclosure are described clearly and completely in conjunction with the drawings of the embodiments of the disclosure hereinafter. It is apparent that the described embodiments are only some rather than all embodiments of the present disclosure. Any other embodiments obtained by those skilled in the art based on the embodiments in the present disclosure without any creative effort shall fall within the protection scope of the present disclosure.

### First Embodiment

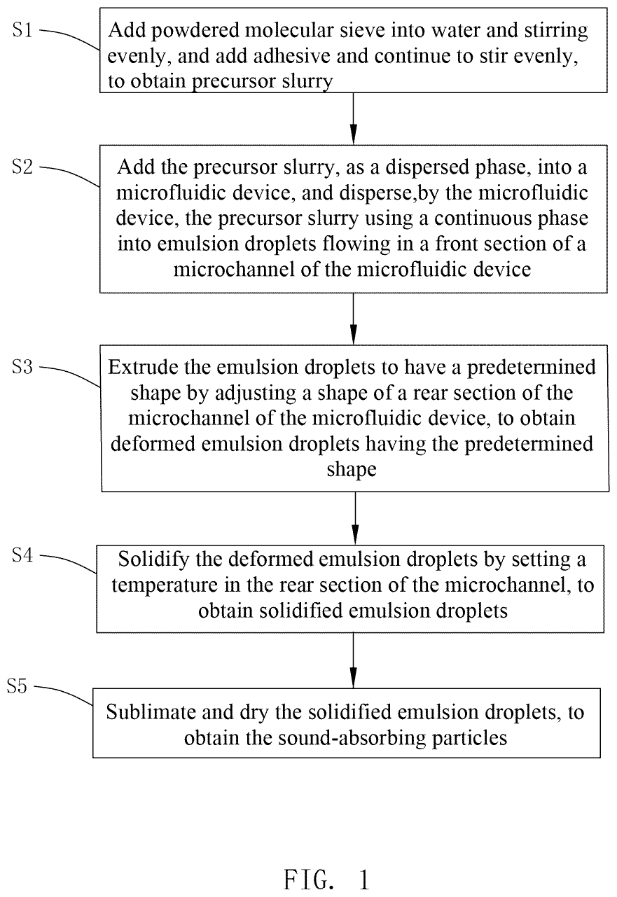

A method for preparing sound-absorbing particles is provided according to embodiments of the present disclosure, which includes the following operations as shown in FIG. 1:
S1, adding powdered molecular sieve into water and stirring evenly, then adding adhesive and continuing to stir evenly, to obtain precursor slurry;
S2, adding the precursor slurry, as a dispersed phase, to a microfluidic device, and dispersing, by the microfluidic device, the precursor slurry using a continuous phase into emulsion droplets flowing in a front section of a microchannel of the microfluidic device;
S3, extruding the emulsion droplets to have a predetermined shape by adjusting a shape of a rear section of the microchannel of the microfluidic device, to obtain deformed emulsion droplets having the predetermined shape;
S4, solidifying the deformed emulsion droplets by setting a temperature in the rear section of the microchannel, to obtain solidified emulsion droplets; and
S5, sublimating and drying the solidified emulsion droplets, to obtain the sound-absorbing particles.

In order to better reflect the beneficial effects brought substantially by the method for preparing the sound-absorbing particles according to the embodiments of the present disclosure, three specific embodiments will be provided below for explanation.

### First Specific Embodiment

A method for preparing sound-absorbing particles is provided according to the first specific embodiment, which includes the following operations.

Operation 1: adding 5 g of powdered ZSM-5 molecular sieve with a silica-aluminum molar ratio of 170 into 5 g of deionized water and stirring evenly, then adding 1 g of an acrylic adhesive with a solid content of 50% and continuing to stir evenly, to obtain precursor slurry with a solidification temperature of substantially 0° C.

Operation 2: adding the precursor slurry, as a dispersed phase, into a dispersed phase reservoir of a microfluidic device, and dispersing, by the microfluidic device, the precursor slurry using a continuous phase into emulsion droplets flowing in a front section of a microchannel of the microfluidic device.

The continuous phase is obtained by adding 5 mL of antifreeze into 15 mL of microdroplet-generating oil and mixing evenly, with a solidification temperature of substantially −15° C. The obtained continuous phase is added into a continuous phase reservoir of the microfluidic device 100.

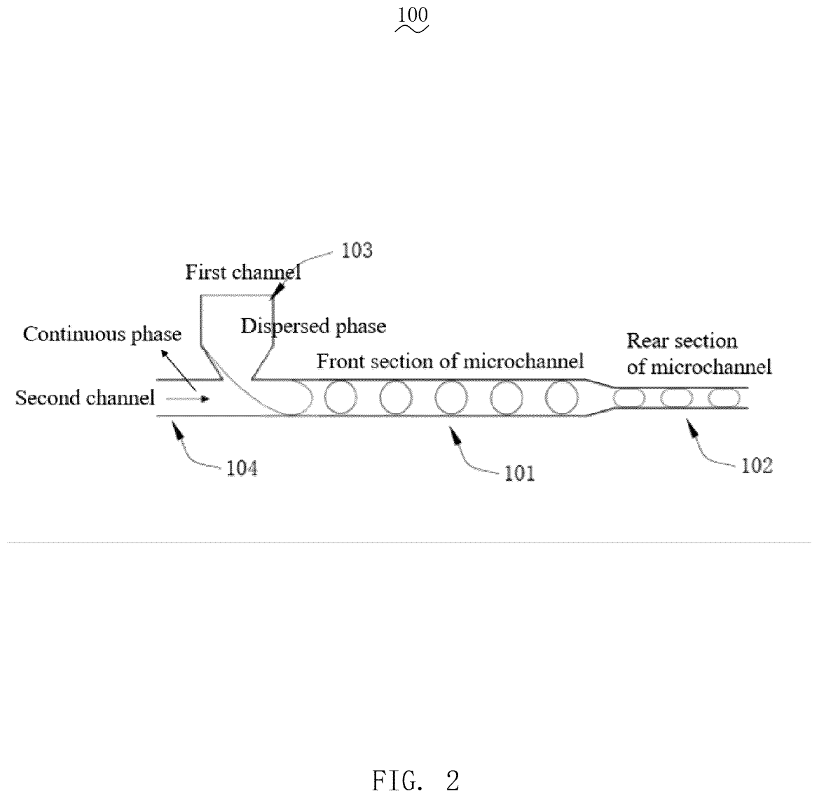

In more detail, as shown in FIG. 2, the microfluidic device 100 adopts a T-shaped vertically staggered microchannel, which includes a first T-shaped vertically staggered channel 103 and a second channel 104. The first channel 103 is connected with the dispersed phase reservoir, the second channel 104 and the front section 101 of the microchannel of the microfluidic device 100 in a T-shape, and the second channel 104 is connected with the continuous phase reservoir and the front section 101 of the microchannel. Flow rates of the first channel 103 and the second channel 104 are set to 15 μL/min and 60 μL/min, respectively. The precursor slurry and the continuous phase flow into the front section 101 of the microchannel simultaneously from the first channel 103 and the second channel 104 respectively, and the precursor slurry is dispersed into the emulsion droplets flowing in the front section 101 of the microchannel through the continuous phase. The front section 101 of the microchannel is a tubular channel with a diameter of 150 μm.

Operation 3: extruding the emulsion droplets in a height direction by adjusting the rear section 102 of the microchannel of the microfluidic device 100 to be a flat channel with a height of 100 μm, to obtain ellipsoidal deformed emulsion droplets.

Since a tube diameter of the front section 101 of the microchannel in the height direction is larger than a tube diameter of the rear section 102 of the microchannel in the height direction, the emulsion droplets flowing from the front section 101 of the microchannel to the rear section 102 of the microchannel is extruded by the rear section 102 of the microchannel, and a maximum cross-sectional area of the emulsion droplets in the front section 101 of the microchannel is larger than a maximum cross-sectional area of the deformed emulsion droplets in the rear section 102 of the microchannel, so as to obtain the ellipsoidal deformed emulsion droplets.

Operation 4: setting a temperature in the rear section 102 of the microchannel to −8° C. and solidifying the deformed emulsion droplets, to obtain solidified emulsion droplets.

Operation 5: placing the solidified emulsion droplets into a low-pressure vacuum environment until all the ice in the solidified emulsion droplets is removed by sublimation, and drying the solidified emulsion droplets in an oven at a temperature of 120° C. for 2 h, to finally obtain ellipsoidal sound-absorbing particles.

In this embodiment, the flat rear section 102 of the microchannel is used to extrude the emulsion droplets in the height direction, so that the ellipsoidal sound-absorbing particles can be formed. Compared with the conventional spherical sound-absorbing particles, the gas has a shorter path in entering an interior of the ellipsoidal sound-absorbing particles, so that the ellipsoidal sound-absorbing particles can adsorb or desorb more gas molecules in a short time, thereby having a better sound-absorbing effect.

### Second Specific Embodiment

A method for preparing sound-absorbing particles is provided according to the second specific embodiment, which includes the following operations.

Operation 1: adding 5 g of powdered ZSM-5 molecular sieve with a silica-iron molar ratio of 290 into 5 g of deionized water and stirring evenly, then adding 1 g of an acrylic adhesive with a solid content of 50% and continuing to stir evenly to obtain precursor slurry with a solidification temperature of substantially 0° C.

Operation 2: adding the precursor slurry, as a dispersed phase, into a dispersed phase reservoir of a microfluidic device, and dispersing, by the microfluidic device, the precursor slurry using a continuous phase into emulsion droplets flowing in a front section of a microchannel of the microfluidic device.

The continuous phase is obtained by adding 5 mL of antifreeze into 15 mL of microdroplet-generating oil and mixing evenly, with a solidification temperature of substantially −15° C. The obtained continuous phase is added into a continuous phase reservoir of the microfluidic device 200.

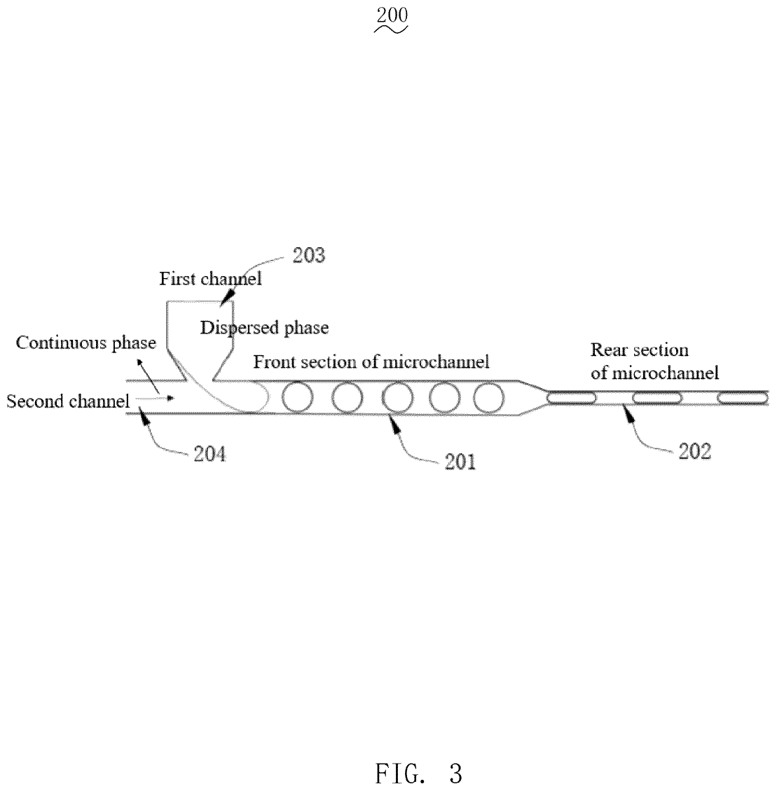

In more detail, as shown in FIG. 3, the microfluidic device 200 adopts a T-shaped vertically staggered microchannel, which includes a first T-shaped vertically staggered channel 203 and a second channel 204. The first channel 203 is connected with the dispersed phase reservoir, the second channel 204 and the front section 201 of the microchannel of the microfluidic device 200 in a T-shape, and the second channel 204 is connected with the continuous phase reservoir and the front section 201 of the microchannel. Flow rates of the first channel 203 and the second channel 204 are set to 15 μL/min and 60 μL/min, respectively. The precursor slurry and the continuous phase flow into the front section 201 of the microchannel simultaneously from the first channel 203 and the second channel 204 respectively, and the precursor slurry is dispersed into the emulsion droplets flowing in the front section 201 of the microchannel through the continuous phase. The front section 201 of the microchannel is a tubular channel with a diameter of 150 μm.

Operation 3: extruding the emulsion droplets by adjusting the rear section 202 of the microchannel of the microfluidic device 200 to be a tubular channel with a diameter of 30 μm, to obtain rod-shaped deformed emulsion droplets.

Since a tube diameter of the front section 201 of the microchannel is larger than a tube diameter of the rear section 202 of the microchannel, the emulsion droplets flowing from the front section 201 of the microchannel to the rear section 202 of the microchannel is extruded by the rear section 202 of the microchannel, and a maximum cross-sectional area of the emulsion droplets in the front section 201 of the microchannel is larger than a maximum cross-sectional area of the deformed emulsion droplets in the rear section 202 of the microchannel, so as to obtain the rod-shaped deformed emulsion droplets.

Operation 4: setting a temperature in the rear section 202 of the microchannel to −8° C. and solidifying the deformed emulsion droplets, to obtain solidified emulsion droplets.

Operation 5: placing the solidified emulsion droplets into a low-pressure vacuum environment until all the ice in the solidified emulsion droplets is removed by sublimation, and drying the solidified emulsion droplets in an oven at a temperature of 120° C. for 2 h, to finally obtain rod-shaped sound-absorbing particles.

In this embodiment, the tubular rear section 202 of the microchannel is used to extrude the spherical emulsion droplets into the rod-shaped emulsion droplets, and the rod-shaped sound-absorbing particles can be formed after solidification and deicing. Compared with the conventional spherical sound-absorbing particles, the rod-shaped sound-absorbing particles have a better degree of looseness when disorderly stacked in the rear cavity of the speaker, thereby improving gas smoothness, and significantly improving the damping of the speaker.

### Third Specific Embodiment

A method for preparing sound-absorbing particles is provided in the third specific embodiment, which includes the following operations.

Operation 1: adding 5 g of powdered molecular sieve with a pure silica MFI structure into 5 g of deionized water and stirring evenly, then adding 1 g of an acrylic adhesive with a solid content of 50% and continuing to stir evenly, to obtain precursor slurry with a solidification temperature of substantially 0° C.

Operation 2: adding the precursor slurry, as a dispersed phase, into a dispersed phase reservoir of a microfluidic device, and dispersing, by the microfluidic device, the precursor slurry using a continuous phase into emulsion droplets flowing in a front section of a microchannel of the microfluidic device.

The continuous phase is obtained by adding 5 mL of antifreeze into 15 mL of microdroplet-generating oil and mixing evenly, with a solidification temperature of substantially −15° C. The obtained continuous phase is added into a continuous phase reservoir of the microfluidic device 300.

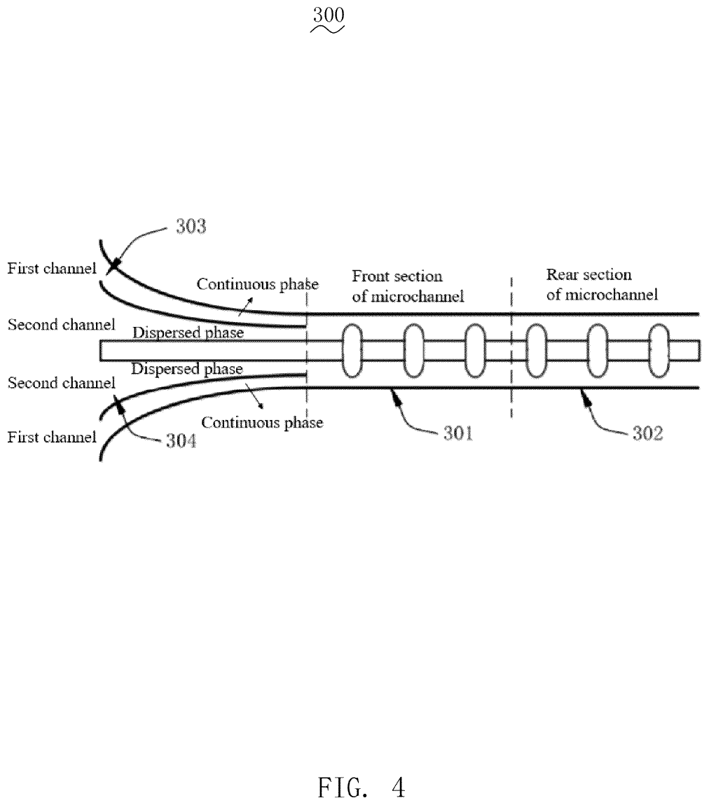

In more detail, as shown in FIG. 4, the microfluidic device 300 adopts a fluid-focusing microchannel, which includes an annular first channel 303 and a second channel 304. The first channel 303 is arranged around an outer side of the second channel 304, and intersects with the second channel 304 at a front end of the front section 301 of the microchannel, the first channel 303 is connected with the continuous phase reservoir and the front section 301 of the microchannel of the microfluidic device 300, and the second channel 304 is connected with the dispersed phase reservoir and the front section 301 of the microchannel. Flow rates of the first channel 303 and the second channel 304 are set to 15 μL/min and 60 μL/min, respectively. The precursor slurry and the continuous phase flow into the front section 301 of the microchannel simultaneously from the first channel 303 and the second channel 304 respectively, and the precursor slurry is dispersed into the emulsion droplets flowing in the front section 301 of the microchannel through the flow plasticity of the continuous phase.

Operation 3: extruding the emulsion droplets by adjusting the rear section 302 of the microchannel of the microfluidic device 300 to be an annular channel with an outer diameter of 150 μm and an inner diameter of 30 μm, to obtain annular deformed emulsion droplets.

In more detail, in this embodiment, the front section 301 of the microchannel and the rear section 302 of the micro-channel have the same channel structure and specification, both of which are annular channels with the outer diameter of 150 μm and the inner diameter of 30 μm. The emulsion droplets are extruded into the annular deformed emulsion droplets from the precursor slurry at the intersection of the first channel 303 and the second channel 304, that is, at the front end of the front section 301 of the microchannel through the flow plasticity of the continuous phase.

Operation 4: setting a temperature in the rear section 302 of the microchannel to −8° C. and solidifying the deformed emulsion droplets, to obtain solidified emulsion droplets.

Operation 5: placing the solidified emulsion droplets into a low-pressure vacuum environment until all the ice in the solidified emulsion droplets is removed by sublimation, and drying the solidified emulsion droplets in an oven at a temperature of 120° C. for 2 h, to finally obtain annular sound-absorbing particles.

In this specific embodiment, the dispersed phase and the continuous phase flow into the middle channel through multiple inlet microchannels. The inlet channels of the continuous phase are annularly distributed on an outer side of the inlet channels of multiple dispersed phases, thereby preparing the annular sound-absorbing particles with good frequency reduction effect and gas smoothness.

According to the above first, second and third specific embodiments, the selected size of the sound-absorbing particles is within a commonly used size range with good sound-absorbing effect, and the size and structure of the sound-absorbing particles can be adjusted as needed in a certain size range or a certain shape range by changing the feeding speed and the tube size of the microfluidic device.

### Second Embodiment

Sound-absorbing particles are provided according to an embodiment of the present disclosure, which are prepared by using the method for preparing the sound-absorbing particles in the first embodiment.

A mass ratio of the molecular sieve, to the adhesive and to the water is 1:0.02-0.20:0.50-2.

The sound-absorbing particles are one of spherical, disc-shaped, elliptical spherical, or rod-shaped. Alternatively, according to customization requirements, the sound-absorbing material can also be in other shapes, such as square, triangle or irregular shape.

Since the sound-absorbing particles are prepared by using the method for preparing the sound-absorbing particles in the first embodiment, the sound-absorbing particles in this embodiment can also achieve the technical effects achieved by the method for preparing the sound-absorbing particles in the first embodiment, which is not described herein.

### Third Embodiment

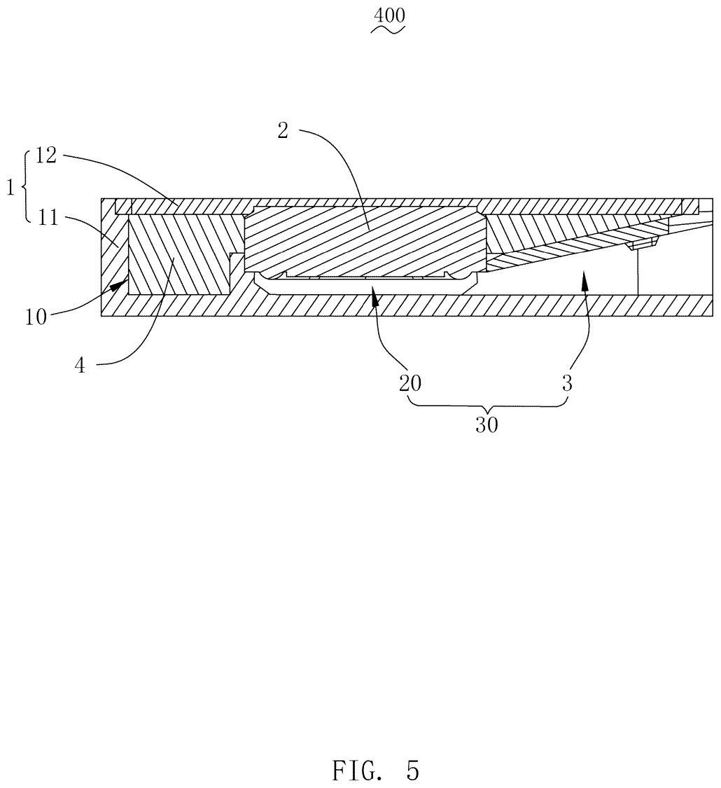

A speaker box 400 is provided according to an embodiment of the present disclosure, shown in FIG. 5, which includes a housing 1 having an accommodating space, a sounding unit 2 accommodated and fixed in the accommodating space, and a sound-conducting channel 3. The housing 1 includes an upper cover 11 and a lower cover 12 cooperating with the upper cover 11, the sound-conducting channel 3 is formed in the upper cover 11, the sounding unit 2, the upper cover 11 and the lower cover 12 jointly define a rear cavity 10, the sounding unit 2 and the upper cover 11 are spaced apart and jointly define a front acoustic cavity 20, the front acoustic cavity 20 is in communication with an exterior environment through the sound-conducting channel 3, the sound-conducting channel 3 and the front acoustic cavity 20 jointly form a front cavity 30, and the rear cavity 10 is filled with sound-absorbing particles 4.

The sound-absorbing particles 4 in this embodiment are the sound-absorbing particles in the second embodiment.

Since the sound-absorbing particles 4 filled in the rear cavity 10 of the speaker box 400 in this embodiment are the sound-absorbing particles in the second embodiment, the sound-absorbing particles 4 in this embodiment can also achieve the technical effects achieved by the method for preparing the sound-absorbing particles in the second embodiment, which is not described herein.

### Fourth Embodiment

An electronic device is provided according to an embodiment of the present disclosure, which includes a speaker box 400 according to the third embodiment.

The electronic device is any device such as a mobile phone, a watch, a tablet computer, a stereo, a notebook computer and the like. Alternatively, according to the actual demand, the electronic device may be a portable game machine, a radios or other device with a speaker box structure.

Since the electronic device in this embodiment is provided with the speaker box 400 in the third embodiment, the electronic device in this embodiment can also achieve the technical effects achieved by the speaker box 400 in the third embodiment, which is not described herein.

The above is only the embodiment of the present disclosure, which does not limit the patent scope of the present disclosure. Any equivalent structure or equivalent process transformation made by using the contents of the specification and drawings of the present disclosure, or directly or indirectly applied to other related technical fields, are equally included in the patent protection scope of the present disclosure.

What is claimed is:

1. A method for preparing sound-absorbing particles, comprising:
S1, adding powdered molecular sieve into water and stirring evenly, and adding adhesive and continuing to stir evenly, to obtain precursor slurry;
S2, adding the precursor slurry, as a dispersed phase, into a microfluidic device, and dispersing, by the microfluidic device, the precursor slurry using a continuous phase into emulsion droplets flowing in a front section of a microchannel of the microfluidic device;
S3, extruding the emulsion droplets to have a predetermined shape by adjusting a shape of a rear section of the microchannel of the microfluidic device, to obtain deformed emulsion droplets having the predetermined shape;
S4, solidifying the deformed emulsion droplets by setting a temperature in the rear section of the microchannel, to obtain solidified emulsion droplets; and
S5, sublimating and drying the solidified emulsion droplets, to obtain the sound-absorbing particles.

2. The method for preparing the sound-absorbing particles of claim 1, wherein a mass ratio of the molecular sieve, to the adhesive, and to the water is 1:0.02-0.10:0.50-2.

3. The method for preparing the sound-absorbing particles of claim 1, wherein the continuous phase added into the microfluidic device for dispersing the dispersed phase includes an oil having a freezing point lower than a freezing point of the precursor slurry.

4. The method for preparing the sound-absorbing particles of claim 3, wherein the continuous phase further includes an unsaturated fatty acid or antifreeze to keep the oil in a flowable liquid state in the microchannel of the microfluidic device.

5. The method for preparing the sound-absorbing particles of claim 1, wherein the front section of the microchannel is tubular, and the rear section of the microchannel is in a preset shape for extruding the emulsion droplets to have the predetermined shape.

6. The method for preparing the sound-absorbing particles of claim 5, wherein a maximum cross-sectional area of the emulsion droplets in the front section of the microchannel is larger than a maximum cross-sectional area of the deformed emulsion droplets in the rear section of the microchannel.

7. The method for preparing the sound-absorbing particle of claim 5, wherein the preset shape is one of a flat shape, a stepped shape, an annular shape and a tubular shape.

8. The method for preparing the sound-absorbing particles of claim 1, wherein the microfluidic device adopts one of a stepped microchannel, a T-shaped vertically staggered microchannel and a fluid-focusing microchannel.

9. The method for preparing the sound-absorbing particles of claim 1, wherein a temperature in the rear section of the microchannel is higher than a temperature of a freezing point of the continuous phase and lower than a temperature of a freezing point of the dispersed phase, and the solidified emulsion droplets are obtained by solidifying the deformed emulsion droplets by the rear section of the microchannel.

10. The method for preparing the sound-absorbing particles of claim 1, wherein the molecular sieve has one or more of an MFI structure, a FER structure, and a MEL structure, the molecular sieve includes silicon oxide and a metal element oxide, a molar ratio of silicon element in the silicon oxide to metal element in the metal element oxide is greater than or equal to 100, and the metal element includes one or more of aluminum, iron, zinc, and zirconium.

11. The method for preparing the sound-absorbing particles of claim 1, wherein the sound-absorbing particles are one of spherical, disc-shaped, elliptical spherical, or rod-shaped.

12. Sound-absorbing particles, prepared by using a method for preparing the sound-absorbing particles,
wherein the method includes:
S1, adding powdered molecular sieve into water and stirring evenly, and adding adhesive and continuing to stir evenly, to obtain precursor slurry;
S2, adding the precursor slurry, as a dispersed phase, into a microfluidic device, and dispersing, by the microfluidic device, the precursor slurry using a continuous phase into emulsion droplets flowing in a front section of a microchannel of the microfluidic device;
S3, extruding the emulsion droplets to have a predetermined shape by adjusting a shape of a rear section of the microchannel of the microfluidic device, to obtain deformed emulsion droplets having the predetermined shape;
S4, solidifying the deformed emulsion droplets by setting a temperature in the rear section of the microchannel, to obtain solidified emulsion droplets; and
S5, sublimating and drying the solidified emulsion droplets, to obtain the sound-absorbing particles.

13. A speaker box, comprising a housing having an accommodating space, a sounding unit accommodated and fixed in the accommodating space, and a sound-conducting channel;
wherein the housing includes an upper cover and a lower cover cooperating with the upper cover, and the sound-conducting channel is formed in the upper cover;
wherein the sounding unit, the upper cover and the lower cover and jointly define a rear cavity, the sounding unit and the upper cover are spaced apart and jointly define a front acoustic cavity, the front acoustic cavity is in communication with an exterior environment through the sound-conducting channel, and the sound-conducting channel and the front acoustic cavity jointly form a front cavity; and
wherein the rear cavity is filled with the sound-absorbing particles of claim 12.

14. An electronic device, comprising the speaker box of claim 13.
